(19) United States
(12) Patent Application Publication
(10) Pub. No.: US 2015/0294423 A1
(43) Pub. Date: Oct. 15, 2015

(54) SYSTEMS AND METHODS FOR FLEXIBLE FIELD MAPPING

(71) Applicant: Thomson Reuters (Markets) LLC, Wilmington, DE (US)

(72) Inventors: Stefan Andreas Blumer, Portland, OR (US); Jennifer Hunsicker, Lake Oswego, OR (US); Neelima Kasa, Portland, OR (US); Richard Allen Padur, Portland, OR (US); Jacob Laux Taber, West Linn, OR (US)

(73) Assignee: Thomson Reuters (Markets) LLC, Wilmington, DE (US)

(21) Appl. No.: 14/251,878

(22) Filed: Apr. 14, 2014

(51) Int. Cl. G06Q 40/00; G06F 17/30

(52) U.S. Cl. CPC G06Q 40/10; G06F 17/30324

(57) ABSTRACT

The present disclosure is directed towards systems and methods for flexible field mapping between disparate systems, which comprises generating a base mapping request comprising a base mapping between a source data object having one or more source data fields and a target data object having one or more target data fields and generating a field mapping request comprising a field mapping between a given source data field and a given target data field. One or more data items are identified from the target data object responsive to the base mapping request and the field mapping request. A combined request is then generated comprising the one or more data items responsive to the base mapping request and the field mapping request. The combined request is transmitted to a target memory. One or more tax values responsive to the combined request are subsequently calculated based on the one or more data items.

A portion of the disclosure of this patent document contains material, which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice applies to this document: Copyright ©2014 Thomson Reuters.

### TECHNICAL FIELD

This disclosure relates generally to field mapping. More specifically, the disclosure is directed towards systems and methods for flexible field mapping between two disparate systems.

### BACKGROUND

Corporate entities often have unique requirements with regard to tax planning and structure. Every company tries to structure their company in the most tax-efficient way. In order to implement its specific requirements, a company must typically program their unique set Of attributes into their Information Technology (“IT”) database infrastructure, such as an Enterprise Resource Planning (“ERP”) infrastructure provided by SAP or Oracle. Traditionally, this task could be quite onerous, and required significant programming skills.

For example, a company's IT department would be required to spend a significant amount of time and resources dedicated to developing thousands of lines of source code to implement the company's individual tax requirements by coding individual field in mappings between the company's tax requirements and the subroutines or user-exits of an ERP infrastructure. Such a process requires extensive efforts by business analysts, programmers and quality assurance specialists to what ultimately results in a simple field mapping. Additionally, a corporate entity would have to undergo this mammoth task every time new tax codes are adopted in order to update the necessary field mappings.

Accordingly, there exists a need for methods and systems that allows a company to set up its IT database infrastructure to suit its individual requirements without writing thousands of lines of code. Such methods and systems would improve efficiency significantly, as a business system analyst can accomplish the task of implementing appropriate tax codes without relying on the support of a programmer with significant coding skills.

### SUMMARY

The present disclosure is directed towards systems and methods for flexible field mapping between disparate systems, by abstracting the hierarchical structure of the data in the disparate systems, e.g. an ERP system such as SAP and tax determination engine.

In one aspect, the method includes generating a base mapping request, the base mapping request comprising a base mapping between a source data object having one or more source data fields and a target data object having one or more target data fields. A field mapping request is also generated, the field mapping request comprising a field mapping between a given source data field and a given target data field. One or more data items are then identified from the target data object responsive to the base mapping request and the field mapping request. In one aspect, a combined request based on the base mapping request and the field mapping request is subsequently generated, the combined request comprising the one or more data items responsive to the base mapping request and the field mapping request. The combined request is then transmitted to a target memory.

According to one embodiment, the method further includes calculating one or more tax values responsive to the combined request based on the one or more data items, transmitting the one or more tax values responsive to the combined request to a source memory and storing ale one or more tax values responsive to the combined request in the source data object maintained in the source memory.

A system, as well as articles that include a machine-readable medium storing machine-readable program code for implementing the various techniques, are disclosed. Details of various embodiments are discussed in greater detail below.

Additional features and advantages will be readily apparent from the following detailed description, the accompanying drawings and the claims.

### BRIEF DESCRIPTION OF THE DRAWINGS

FIG. 1 is a schematic depicting an exemplary computer-based system for flexible field mapping between two disparate systems;

FIG. 2 is a flow diagram illustrating an exemplary computer-implemented method for flexible field mapping between two disparate systems;

FIG. 3 is an illustration of an exemplary graphical user interface for flexible field mapping between two disparate systems; and

FIG. 4 is an illustration of another exemplary graphical user interface for flexible field mapping between two disparate systems.

Like reference symbols in the various drawings indicate like elements.

### DETAILED DESCRIPTION

In the following description, reference is made to the accompanying drawings that form a part hereof, in which is shown by way of illustration specific embodiments in which the disclosure may be practiced. It is to be understood that other embodiments may be utilized and structural changes may be made without departing from the scope of the present disclosure.

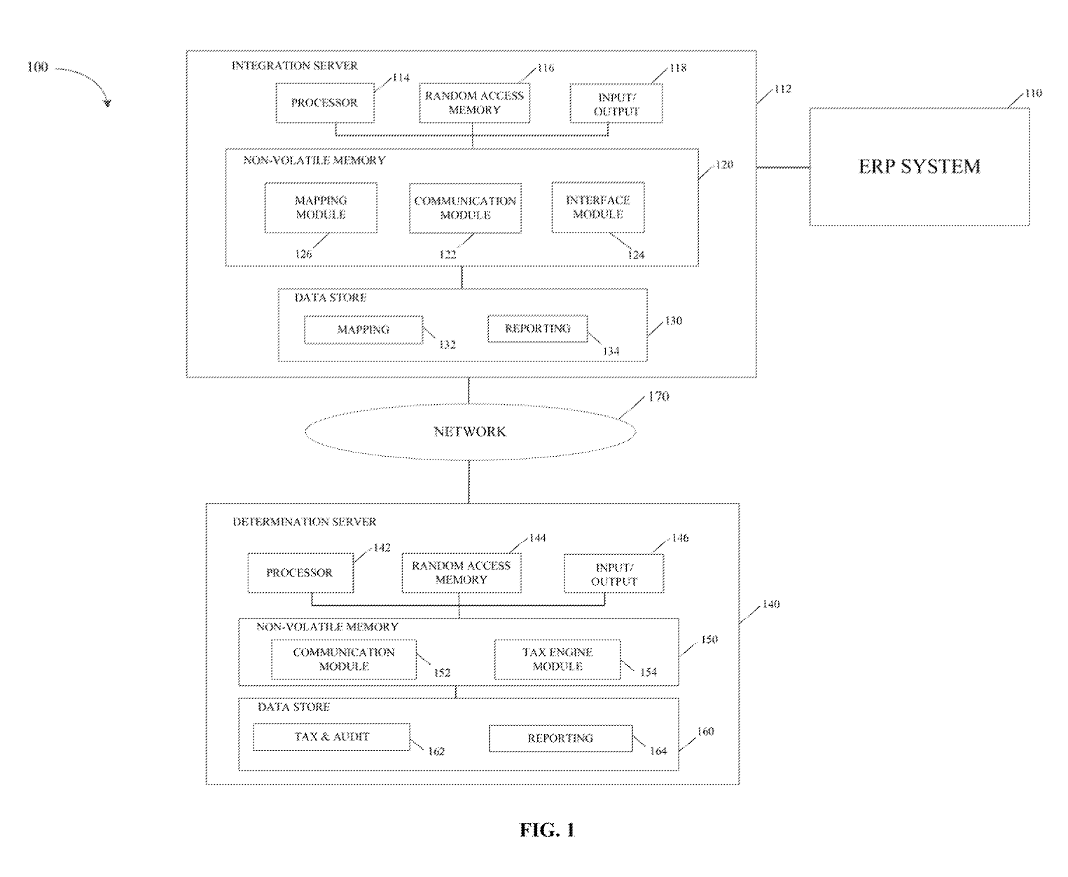

Turning now to FIG. 1, an example of a suitable computing system 100 within which embodiments of the disclosure may be implemented is presented. The computing system 100 is only one example and is not intended to suggest any limitation as to the scope of use or functionality of the disclosure. Neither should the computing system 100 be interpreted as having any dependency or requirement relating to any one or combination of illustrated components.

For example, the present disclosure is operational with numerous other general purpose or special purpose computing consumer electronics, network PCs, minicomputers, mainframe computers, laptop computers, as well as distributed computing environments that include any of the above systems or devices, and the like.

The disclosure may be described in the general context of computer-executable instructions, such as program modules, being executed by a computer. Generally, program modules include routines, programs, objects, components, data structures, loop code segments and constructs, etc. that perform particular tasks or implement particular abstract data types. The disclosure can be practiced in distributed computing environments where tasks are performed by remote processing devices that are linked through a communications network. In a distributed computing environment, program modules are located in both local and remote computer storage media including memory storage devices. Tasks performed by the programs and modules are described below and with the aid of figures. Those skilled in the art can implement the description and figures as processor executable instructions, which can be written on any form of a computer readable media.

In one embodiment, with reference to FIG. 1, the system 100 includes an integration server device 112 and the determination server device 140. The integration server device 112 is configured to include a processor 114, such as a central processing unit (“CPU”), random access memory (“RAM”) 116, one or more input-output devices 118, such as a display device (not shown) and keyboard (not shown), non-volatile memory 120 and a data store 130, all of which are interconnected via a common bus and controlled by the processor 114.

According to one embodiment, the integration server 112 serves as middleware and is connected to an ERP System 110. In another embodiment, the integration server 112 is part of the ERP system 110. In one embodiment, the ERP System 110 is an enterprise resource planning system comprising a suite of business management software applications used by an organization to provide real-time view of core business processes, using common databases maintained by a database management system. For example, the ERP System 110 tracks business resources, such as cash or inventory, and the status of business commitments, such as issuing of purchase orders, and payment of invoices, processing of receivables and payables, all of which involve the calculation of applicable taxes.

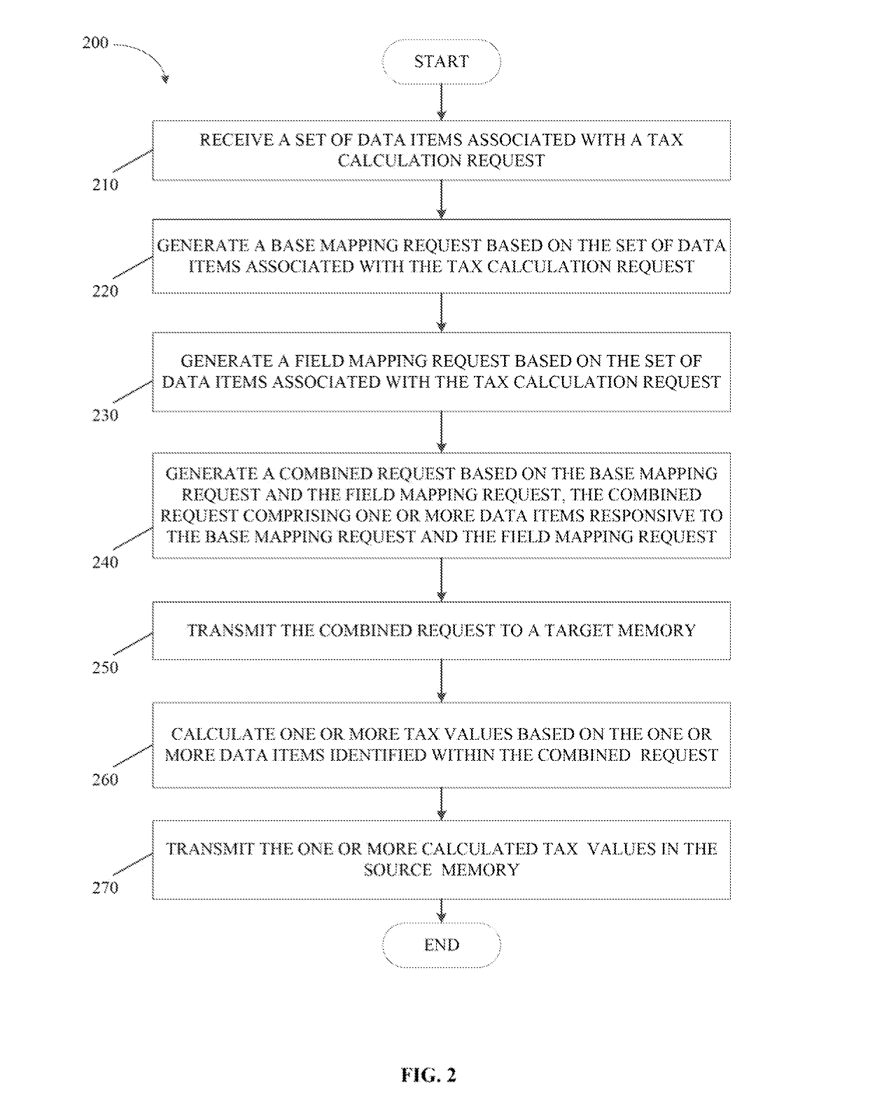

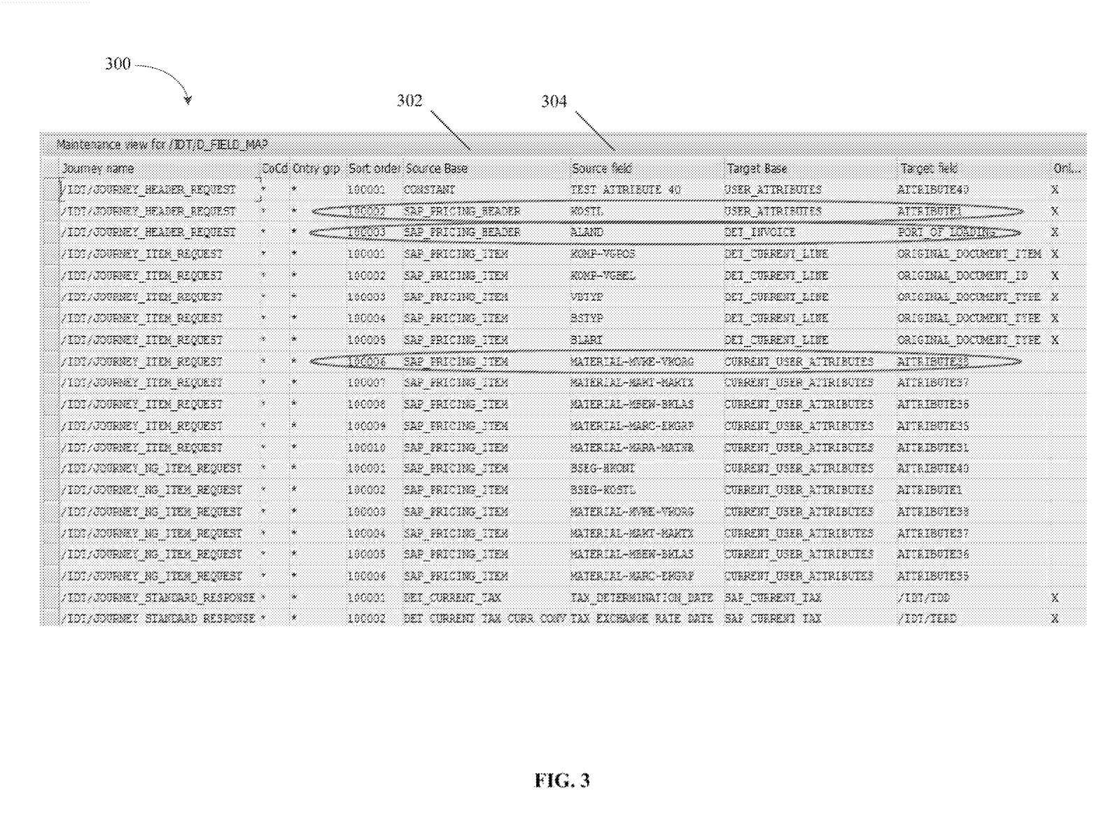

As shown in the FIG. 1 example, in one embodiment, the non-volatile memory 120 of the integration server 112 is configured to include a communication module 122, an interface module 124 and a mapping module 126. The interface module 124 is configured to generate a graphical user interface (“GUI”) and present the GUI to an end user utilizing the ERP System 110. The methods and components used to generate and present the GUI are known in the art. The interface module 124 is further configured to receive a set of data items received through the user interface and to transmit and present identified tax rates and calculated tax values responsive to a tax calculation request. The mapping module 126 is configured to receive the set of data items from the interface module 124 and generate one or more mapping requests to be transmitted to the determination server 140. The communication module 122 is provided to receive the one or more mapping requests, and to generate and transmit a signal associated with the one or more mapping requests. The communication module 122 is further configured to receive one or more calculated value data items, such as a calculated tax value, from the determination server 140. Additional details of modules 122, 124 and 126 are discussed in connection with FIGS. 2-3.

The data store 130 of the integration server 112 is a repository that maintains and stores information utilized by the before-mentioned modules 1 22. 124 and 126. In one embodiment, the data store 130 is a relational database. In another embodiment, the data store 130 is a directory server, such as a Lightweight Directory Access Protocol (“LDAP”). In yet another embodiment, the data store 130 is an area of non-volatile memory 120 of the server device 112.

In one embodiment, as shown in the FIG. 1 example, the data store 130 includes a mapping database 132 and a reporting database 134. The mapping database 132 is configured to maintain a set of mappings between one or more data items in the ERP system 110 and one or more data items in the determination server 140, as well as a mirrored copy of a series of data objects in the form of data tables, which includes tax rate information corresponding to individual data fields, maintained in a tax and audit database 162 of the determination server 140. The reporting database 134 is operative to store identified tax rates and calculated tax values responsive to a tax calculation request received from determination server 140.

Although the data store 130 shown in FIG. 1 is connected to the network 170, it will be appreciated by one skilled in the art that the data store 130 and/or any of the information shown therein, can be distributed across various servers and be accessible to the determination server 140 over the network 170, be coupled directly to the determination server 140, or be configured in an area of non-volatile memory 150 of the determination server 140.

According to one embodiment, the determination server device 140 is configured to include a processor 142, such as a CPU, a random access memory 144, one or more input-output devices 146, such as a display device (not shown) and keyboard (not shown), non-volatile memory 150 and a data store 160, all of which are interconnected via a common bus and controlled by the processor 142. As shown in the FIG. 1 example, in one embodiment, the non-volatile memory 150 of the determination server device 140 is configured to include a communication module 152 and a tax engine module 154.

The communication module 152 is configured to receive the one or more mapping requests from the integration server 112. The tax engine module 154 is operative to receive the one or more mapping requests from the communication module 152 and determine a calculated data value item, such as a calculated tax value, using the one or more mapping requests and the one or more tax rules maintained in the tax and audit database 162 within the data store 160 of the determination server 140. Additional details of modules 152 and 154 are discussed in connection with FIGS. 2-3.

The data store 160 of the determination server 140 is a repository that maintains and stores information utilized by the before-mentioned modules 152 and 154. In one embodiment, the data store 160 is a relational database. In another embodiment, the data store 160 is a directory server, such as a Lightweight Directory Access Protocol (“LDAP”). In yet another embodiment, the data store 160 is an area of non-volatile memory 150 of the determination server 140.

In one embodiment, as shown in the FIG. 1 example, the data store 160 includes the tax and audit database 162 and the reporting database 164. The tax and audit database 162 is configured to maintain a series of data objects in the form of data tables, which includes tax rate information corresponding to individual data fields. The reporting database 164 is operative to store tax rates identified by and tax values responsive to a tax calculation request calculated by the tax engine module 154.

Although the data store 160 shown in FIG. 1 is connected to the network 170, it will be appreciated by one skilled in the art that the data store 160 and/or any of the information shown therein, can be distributed across various servers and be accessible to the determination server 140 over the network 170, be coupled directly to the determination server 140, or be configured in an area of non-volatile memory 150 of the determination server 140.

As shown in FIG. 1, in one embodiment, a network 170 is provided that can include, various devices such as routers, server, and switching elements connected in an Intranet, Extranet or Internet configuration. In one embodiment, the network 170 uses wired communications to transfer information between the integration server 112 and the determination server 140. In another embodiment, the network 170 employs wireless communication protocols to transfer information between the integration serve 112 and the determination server 140. For example, the network 170 may be a cellular or mobile network employing digital cellular standards including but not limited to the 3GPP, 3GPP2 and AMPS family of standards such as Global System for Mobile Communications (GSM), General Packet Radio Service (GPRS), CDMAOne, CDMA2000, Evolution-Data Optimized (EV-DO), LTE Advanced, Enhanced Data Rates for GSM Evolution (EDGE), Universal Mobile Telecommunications System (UMTS), Digital Enhanced Cordless Telecommunications (DECT), Digital AMPS (IS-136/TDMA), and Integrated Digital Enhanced Network (iDEN). The network 170 may also be a Wide Area Network (WAN), such as the Internet, which employs one or more transmission protocols, e.g. TCP/IP. As another example, the network 170 may employ a combination of digital cellular standards and transmission protocols. In yet other embodiments, the network 170 employs a combination of wired and wireless technologies to transfer information between the integration serve 112 and the determination server 140.

Further, it should be noted that the system 100 shown in FIG. 1 is only one embodiment of the disclosure. Other system embodiments of the disclosure may include additional structures that are not shown, such as secondary storage and additional computational devices. In addition, various other embodiments of the disclosure include fewer structures than those shown in FIG. 1. For example, in one embodiment, the disclosure is implemented on a single computing device in a non-networked standalone configuration. Data input and requests are communicated to the computing device via an input device, such as a keyboard and/or mouse. Data output, such as the computed significance score, of the system is communicated from the computing device to a display device, such as a computer monitor.

Turning now to FIG. 2, an exemplary method 200 for flexible field mapping between two disparate systems is disclosed. In the illustrated embodiment shown in FIG. 2, the interface module 124 receives a set of data items associated with a tax calculation request, step 210. According to one embodiment, the interface module 124 generates and presents a user interface in which a user of the ERP system 110 inputs the set of data items associated with a tax calculation request. The set of data items, in one embodiment, includes one or more source base values and one or more source field values. An exemplary user interface 300 is shown in FIG. 3, in which a user inputs the source base as an entry in column 302 and the source field as an entry in column 304.

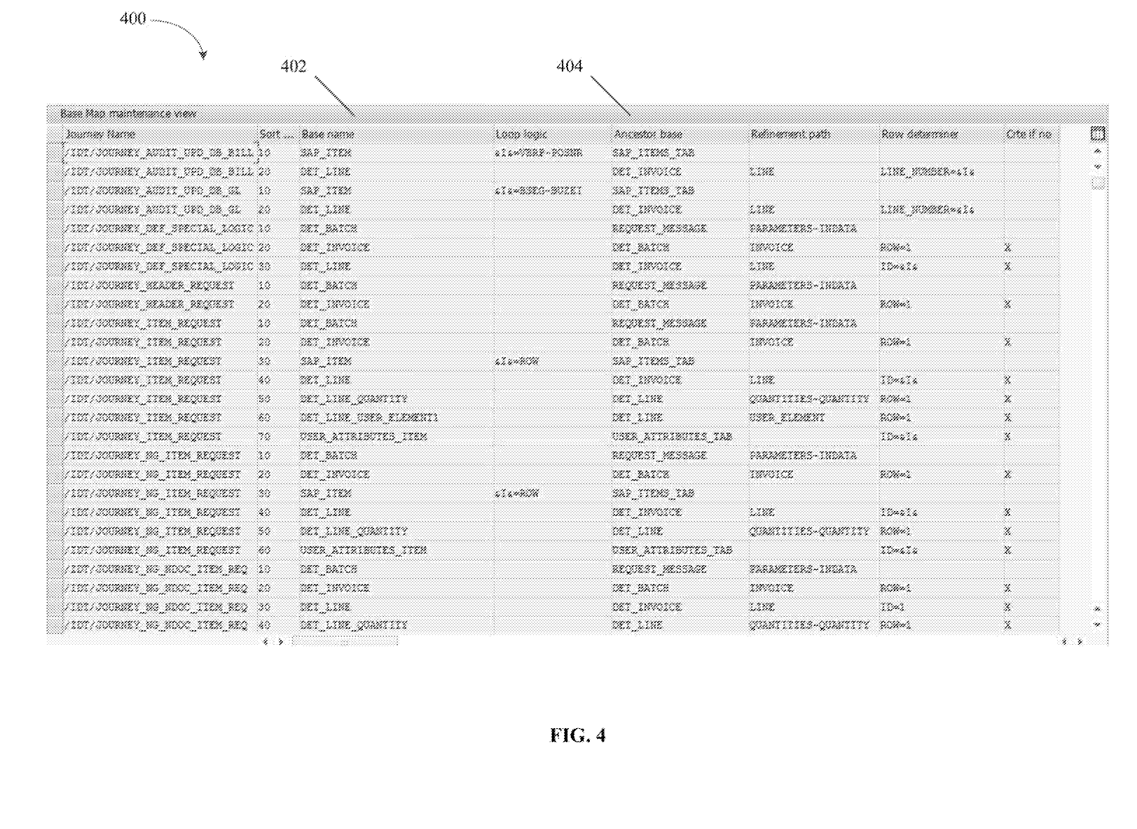

A source base, in one embodiment, is a data item that defines the primary level where the source data resides, such as a document or line level. An exemplary user interface 400 is shown in FIG. 4, which according to one embodiment, is accessible by a user in a read-only format for presentational purposes, and which demonstrates the hierarchal relationship of the source base. In one embodiment, as illustrated in FIG. 4, the hierarchal relationship is demonstrated between the ancestor base 404 and the source base 402 where the source data resides. The source data is the data from a source document, such as a draft purchase order, invoice or receipt, which a tax calculation is requested for.

In one example, a source document may be a draft invoice, which typically outlines a list of goods that are being purchased, as well as any associated costs or fees for the delivery of goods, such as any delivery surcharges or set up fees. Each of the line items within the invoice may have a tax imposed by an applicable government fir the sale of the individual items and for the fees for services provided, such as the delivery surcharge. In an ERP system, such as SAP's Enterprise Resource Planning (“ERP”) system, the invoice is generated listing the products and services, each of which may require a tax to be calculated and included as part of the final invoice that is to be generated and presented to the ultimate purchaser of the goods and services. For example, an invoice specifying the sale of one hundred tires in the State of New York in the United States would require the calculation and inclusion of the applicable sales tax to be applied to the sale of the one hundred tires. In this example, the source base would the document header specifying a purchase order document type within the ERP system, which in the case of the SAP ERP system, would be “SAP_PRICING_HEADER.” Alternatively, a source base may be at the line item level within a source document, such as the purchasing data within an invoice, and may be specified, in the case of the SAP ERP system, as “SAP_PRICING_ITEM.”

A source field, in one embodiment, specifies the specific field within the source base that needs to be mapped it order to satisfy the tax determination request. According to one embodiment, the source base and source field maintain a hierarchal relationship, allowing for easier and faster subsequent processing. Continuing from the previous example, where a draft invoice outlines the sale of one hundred tires, a source field includes any one of the necessary fields within the invoice that is needed to calculate the applicable sales tax, such as the location where the items are to be delivered. In the case of the SAP ERP system, for the draft invoice of the sale of one hundred tires, the source base would be “SAP_PRICING_HEADER,” which specifies that a SAP document level is to be mapped, and the source field may be “KOMK-ALAND,” which specifies the country of origin for the invoice. A non-exhaustive list of the types of source field data include: date, location, exchange rate information, material type information, quantity, vendor information, customer information and shipping information.

Returning to FIG. 2, according to one embodiment, at step 220, the mapping module 126 generates a base mapping request based on the set of data items associated with the tax calculation request. The base mapping request comprises a mapping between a source data object having one or more source data fields and a target data object having one or more target data fields. According to one embodiment, the base mapping request is generated using the one or more source base values, which as discussed previously, identify the document or line item level of a source document that are to be mapped. In one embodiment, an ERP system generates a source document using one or more source data objects, such as a series of data tables as is known in the art, and the source fields can be any one of the fields with the source data objects used to generate the source document.

In one embodiment, the mapping module 126 interrogates the mapping database 132 in order to identify the corresponding target base. As discussed previously, the mapping database 132 maintains a series of data tables that maps source bases, and associated source fields, from an ERP system to corresponding target bases, and associated target fields, in a target system, such as a tax determination engine. Continuing from the previous example, where the source base is identified as “SAP_PRICING_HEADER,” specifying that a SAP document level is to be mapped, the corresponding target base is identified from the mapping database 132 as “DET_INVOICE,” which is the document header for an invoice type within a tax determination system, such as within Thomson Reuters ONESOURCE Indirect Tax Global Tax Determination product offering.

In one embodiment, mapping module 126 further interrogates the mapping database 132, which further maintains source code for effectuating the call to a target system with the necessary mapping instructions to map the source base to the corresponding target base. According to one embodiment, the base mapping request is generated by the mapping module 126 by structuring the applicable source code maintained in the napping database 132 into a request, such as an XML request, providing mapping instructions between the source base and identified target base.

At step 230, a field mapping request is generated by the mapping module 126 based on the set of data items associated with the tax calculation request. According to one embodiment, the mapping module 126 interrogates the mapping database 132 it order to identify the target field to the corresponding source field. Continuing from the previous, the source field having been identified as “KOMK-ALAND,” which specifies the country of origin for the invoice, is mapped to the target field “PORT OF LOADING” under the target base “DET_INVOICE.” According to one embodiment, the target base and target field maintain a hierarchal relationship, similar to that of the hierarchal relationship between the source base and source field, allowing for quicker and efficient mapping of the source field and target field by filtering the applicable fields to be mapped according to the associated bases.

In one embodiment, mapping module 126 further interrogates the mapping database 132, which also maintains source code for effectuating the call to a target system with the necessary mapping instructions to map the source field to the corresponding target field. According to one embodiment, the field mapping request is generated by the mapping module 126 by structuring the applicable source code maintained in the mapping database 132 into a request, such as an XML request, providing mapping instructions between the source field and the identified target field.

According to another embodiment, the target base and field are identified and input into the user interface, along with the source base and source target, by the user of the ERP system 110, which is subsequently received by the interface module 124, in which case the mapping module 126 generates both the base mapping request and the field mapping request based on the inputs provided from the ERP system 110. In another embodiment, the target base are identified and input into the user interface, along with the source base and source target, by the user of the ERP system 110, in which case the mapping module 126 generates the base mapping request based on the inputs provided from the ERP system 110 and generates the field mapping request by identifying the target field using the mappings stored in the mapping database 132.

Returning to FIG. 2, according to one embodiment, at step 240, the mapping module 126 subsequently generates a combined request based on the base mapping request and the field mapping request, the combined request comprising one or more data items responsive to the base mapping request and the field mapping request. In one embodiment, the mapping module 126 interrogates the mapping database 132 using the base mapping request and the field mapping request in order to identify one or more one or more data items responsive to the base mapping request and the field mapping request. In one embodiment, the one or more data items responsive to the base mapping request and the field mapping request are the one or more applicable tax rates associated with the target field.

As discussed previously, the tax and audit database 162, in one embodiment, maintains a series of data objects in the form of data tables, which includes the hierarchal structure of target bases and associated target fields, as well as tax rate information corresponding to individual target fields. This series of data objects are mirrored in the mapping database 132. For example, the mapping database 132 minors that tax and audit database 162, which maintains the sales tax rate for the sale of tires in the State of New York within the United States, the importation tariff for the importation of tires into the United States from Mexico expressed as both US Dollars and Mexican Pesos and the shipping and delivery taxes fir the transport of tires from the State of Texas to the States of New York, i.e. tax rates are maintained for target fields related to materials type, service type, location, and currency within the target base of an invoice.

Returning to step 240 of FIG. 2, one or more data items responsive to the base mapping request and the field mapping request are identified by the mapping module 126 interrogating the series of data objects, which includes the hierarchal structure of target bases and associated target fields, as well as tax rate information corresponding to individual target fields, mirrored in the mapping database. In one embodiment, the one or more data items responsive to the combined mapping request include the applicable tax rates associated with the identified target field, which are identified by the mapping module 126 by first mapping the source base to the target base located within the appropriate target data object mirrored in the flapping database 132 from the tax and audit database 162. The mapping module 126 subsequently maps the source field to the corresponding target field within the target base of the target data object. Upon completion of the mapping procedure, the mapping module 126 identifies one or more applicable tax rates associated with the target field and stores the identified rates within the reporting database 134 of the integration server 112.

The mapping module 126 then generates the combined request, which according to one embodiment, includes the necessary source code, such as in an XML request, which provides instructions to calculate a tax value based on the one or more data items responsive to the base mapping request and the field mapping request. In one embodiment, the combined request includes the one or more data items in the form of one or more applicable tax rates for the target field identified in response to the base mapping request and the field mapping request

At step 250, according to one embodiment, the communication module 122 of integration server 112 transmits the combined request generated by the mapping module 126 to a target memory. According to one embodiment, the target memory includes the reporting database 164 of the determination server 140, which receives the combined request via the communication module 152 of the determination server 140. In one embodiment, the combined request is transmitted using the communication protocols known in the art, such as Simple Object Access Protocol (“SOAP”).

At step 260, one or more tax values are calculated by the tax engine module 154 based on the one or more data items identified as responsive to the combined mapping request and stored in the reporting database 164. According to one embodiment, tax engine module 154 uses the identified tax rates stored in the reporting database 164 to calculate one or more applicable tax values. For example, to calculate the relevant tax values for the sale of tires presented in an invoice, the requisite tax would be the sales tax for the State of New York, which would be by using the total sales price and calculate the tax value based on a sales tax. rate of 8.625%. In one embodiment, the sales price is identified by the tax engine module 154 from the information provided as pan of the combined mapping request. In another embodiment, the sales price would be provided separately by the user at the ERP system 110, via the interface module 124 and the communication module 122 and 152.

At step 280, the one or more tax values and the one or more data items responsive to the combined request are then transmitted by the communication 152 to the communication module 122 and stored in the source memory. In one embodiment, the one or more data items responsive to the combined request include the calculated tax value and the identified tax rates, which the communication module 122 stores in the reporting module 134, which is subsequently presented to the ERP system 110 by the interface module 134 and stored therein.

FIGS. 1 through 3 are conceptual illustrations allowing for an explanation of the present disclosure. It should be understood that various aspects of the embodiments of the present disclosure could be implemented in hardware, firmware, software, or combinations thereof. In such embodiments, the various components and/or steps would be implemented in hardware, firmware, and/or software to perform the functions of the present disclosure. That is, the same piece of hardware, firmware, or module of software could perform one or more of the illustrated blocks (e.g., components or steps).

In software implementations, computer software (e.g. programs or other instructions) and/or data is stored on a machine readable medium as part of a computer program product, and is loaded into a computer system or other device or machine via a removable storage drive, hard drive, or communications interface. Computer programs (also called computer control logic or computer readable program code) are stored in a main and/or secondary memory, and executed by one or more processors (controllers, or the like) to cause the one or more processors to perform the functions of the disclosure as described herein. In this document, the terms “machine readable medium,” “computer program medium” at “computer usable medium” are used to generally refer to media such as a random access memory (RAM); a read only memory (ROM); a removable storage unit (e.g., a magnetic or optical disc, flash memory device, or the like); a hard disk; or the like.

Notably, the figures and examples above are not meant to limit the scope of the present disclosure to a single embodiment, as other embodiments are possible by way of interchange of some or all of the described or illustrated elements. Moreover, where certain elements of the present disclosure can be partially or fully implemented using known components, only those portions of such known components that are necessary for an understanding of the present disclosure are described, and detailed descriptions of other portions of such known components are omitted so as not to obscure the disclosure. In the present specification, an embodiment showing a singular component should not necessarily be limited to other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present disclosure encompasses present and future known equivalents to the known components referred to herein by way of illustration.

The foregoing description of the specific embodiments so fully reveals the general nature of the disclosure that others can, by applying knowledge within the skill of the relevant art(s) (including the contents of the documents cited and incorporated by reference herein), readily modify and/or adapt for various applications such specific embodiments, without undue experimentation, without departing from the general concept of the present disclosure. Such adaptations and modifications are therefore intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance presented herein, in combination with the knowledge of one skilled in the relevant art(s).

While various embodiments of the present disclosure have been described above, it should be understood that they have been presented by way of example, and not limitations. It would be apparent to one skilled in the relevant art(s) that various changes in form and detail could be made therein without departing from the spirit and scope of the disclosure. Thus, the present disclosure should not be limited by any of the above-described exemplary embodiments, but should be defined only in accordance with the following claims and their equivalents.

What is claimed is:

1. A computer-implemented method for flexible field mapping, the method comprising:
generating a base mapping request, the base mapping request comprising a base mapping between a source data object having one or more source data fields and a target data object having one or more target data fields;
generating a field mapping request, the field mapping request comprising a field mapping between a given source data field and a given target data field;
identifying one or more data items from the target data object responsive to the base mapping request and the field mapping request;
generating a combined request based on the base mapping request and the field mapping request, the combined request comprising the one or more data items responsive to the base mapping request and the field mapping request; and
transmitting the combined request to a target memory.

2. The computer-implemented method of claim 1, further comprising:
calculating one or more tax values responsive to the combined request based on the one or more data items;
transmitting the one or more tax values responsive to the combined request to a source memory; and
storing the one or more tax values responsive to the combined request in the source data object maintained in the source memory.

3. The computer-implemented method of claim 1, wherein transmitting the combined request to a target memory comprising the target data object further comprises transmitting the combined request using Simple Object Access Protocol.

4. The computer-implemented method of claim 1, wherein the target data object is stored in the target memory and a copy of the target data object is stored in an intermediate memory.

5. Non-transitory computer readable media comprising program code stored thereon for execution by a programmable processor to perform a method for flexible field mapping, the computer readable media comprising:
program code for generating a base mapping request, the base mapping request comprising a base mapping between a source data Object having one or more source data fields and a target data object having one or more target data fields;
program code for generating a field mapping request, the field mapping request comprising a field mapping between a given source data field and a given target data field;
program code for identifying one or more data items from the target data object responsive to the base mapping request and the field mapping request;
program code for generating a combined request based on the base mapping request and the field mapping request, the combined request comprising the one or more data items responsive to the base mapping request and the field mapping request; and
program code for transmitting the combined request to a target memory.

6. The computer readable media of claim 6, further comprising:
program code for calculating one or more tax values responsive to the combined request based on the one or more data items;
program code for transmitting the one or more tax values responsive to the combined request to a source memory; and
program code for storing the one or more tax values responsive to the combined request in the source data object maintained in the source memory.

7. The computer readable media of claim 7, wherein program code for tray the combined request to a target memory comprising the target data object further comprises program code for transmitting the combined request using Simple Object Access Protocol.

8. The computer readable media of claim 7, wherein the target data object is stored in the target memory and a copy of the target data object is stored in an intermediate memory.

9. A system for flexible field mapping, the system comprising:
a first server including a processor configured to:
generate a base mapping request, the base mapping request comprising a base mapping between a source data object having one or more source data fields and a target data object having one or more target data fields;
generate a field mapping request, the field mapping request comprising a field mapping between a given source data field and a given target data field;
identify one or more data items from the target object responsive to the base mapping request and field mapping request;
generate a combined request based on the base mapping request and the field mapping request, the combined request comprising the one or more data items responsive to the base mapping request and the field mapping request; and
transmit the combined request to a target memory within a target server.

10. The system of claim 11, wherein the target server is configured to:
calculate one or more tax values responsive to the combined request based on the one or more data items;

11. The system of claim 11, wherein the server is configured to:
transmit the one or more tax values responsive to the combined request to a source memory; and
store the one or more tax values responsive to the combined request in the source data object maintained in the source memory.

12. The system of claim 11, wherein the server, in transmitting the combined request to a target memory comprising the target data object, is further configured to transmit the combined request using Simple Object Access Protocol.

13. The system of claim 11, wherein the target data object is stored in the target memory within the target server and a copy of the target data object is stored in an intermediate memory within the server.
